(19) United States
(12) Patent Application Publication
(10) Pub. No.: US 2009/0207237 A1
(43) Pub. Date: Aug. 20, 2009

(54) Method and Device for Autosterioscopic Display With Adaptation of the Optimal Viewing Distance

(76) Inventors: Xavier Leveco, Gif sur Yvette (FR); Samuel Bucourt, Forges-les-Bains (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/988,267

(22) PCT Filed: Jul. 3, 2006
(86) PCT No.: PCT/FR2006/001564

§ 371 Date: Apr. 30, 2008

(30) Foreign Application Priority Data
Jul. 4, 2005 (FR) 0507101

(51) Int. Cl. H04N 13/04

(52) U.S. Cl. 348/51; 348/E13.001

(57) ABSTRACT

A method for autostereoscopic viewing including encoding a matrix image on a display, the matrix image integrating a set of P view points of the same scene. The matrix image consists of image pixels, and P image pixels forming a 3D image including P view points. The display includes a matrix of screen pixels, the screen pixels including P view points forming a 3D screen pixel. The method further includes receiving and optically processing a matrix image, emitted by the display, with a converting display, remotely generating a three-dimensional image. The device and method further include adapting the number of screen pixels to encode a 3D image pixel, based on a desired optimal viewing distance (Dₒₚₜ). The invention is particularly useful for computer displays or three-dimensional television sets.

### RELATED APPLICATIONS

This application claims priority to PCT Application No. PCT/FR2006/001564 filed Jul. 3, 2006, and French Application No. 0507101 filed Jul. 4, 2005, the disclosures of which are hereby incorporated by reference in their entireties.

### TECHNICAL FIELD

The present invention relates to a method for autostereoscopic display with adaptation of the optimal viewing distance. It also relates to an autostereoscopic display device implementing this method.

The present invention therefore relates to three-dimensional computer or television screens, intended for example to broadcast advertisements or information to the public or to display informational or entertainment content.

### BACKGROUND OF THE INVENTION

It is currently known how to produce devices for autostereoscopic display without glasses. These devices are composed, on the one hand, of a two-dimensional screen based, for example, on liquid crystal or plasma technology, and, on the other hand, a 2D-3D conversion screen arranged at a small distance from the two-dimensional screen. This conversion screen can, for example, consist either of a parallax barrier composed of an alternation of opaque and transparent fine bands, or of a lenticular network including a layer of semi-cylindrical lenses parallel to one another.

The conversion screen enables an angular selection of pixels of the two-dimensional screen, which makes it possible to send different information to the left eye and to the right eye of a viewer of an autostereoscopic display device, giving the viewer an impression of volume if the successive pixels of the two-dimensional display screen encode P view points of the same scene, slightly angularly offset.

The optimal viewing distance Dₒₚₜ of an autostereoscopic display device is dependent on the geometric and physical properties of the components of said autostereoscopic device. The more the distance D, between a viewer and the autostereoscopic device, is different from Dₒₚₜ, the more the three-dimensional image perceived by the viewer is blurred and unpleasant to watch.

It would therefore be beneficial to provide a method for adapting the optimal viewing distance of an autostereoscopic device.

Such a device is described in U.S. Pat. No. 6,876,495, entitled “Structured Light Source.” This document discloses an autostereoscopic display device including, as a conversion screen, a lenticular network, and, as a matrix display screen, a screen based, for example, on liquid crystal technology. To modify the Dₒₚₜ, it is proposed to slightly modify the distance of separation between the lenticular network and the matrix screen.

Such a device is also described in U.S. Pat. No. 6,752,498 entitled “Adaptive Autostereoscopic Display System.” The autostereoscopic display device is different from that of the previous reference, but the solution presented for modifying the Dₒₚₜ in this case also consists of moving various optical elements composing the device, such as projection apparatuses, lenses or a mirror.

### SUMMARY OF THE INVENTION

The objective of the present invention is to propose a method for adapting the optimal viewing distance Dₒₚₜ of an autostereoscopic device without moving one of the elements constituting the autostereoscopic device.

This objective is achieved with an autostereoscopic display method including the steps of:
encoding a matrix image on a matrix display screen, wherein said matrix image integrates a set of P view points of the same scene, said matrix image is composed of image pixels, an image pixel includes a view point, P image pixels form a 3D image pixel including P view points, said display screen includes a matrix of screen pixels, and a plurality of screen pixels all include P points of view forming a 3D screen pixel,
receiving and optically processing a matrix image, transmitted by said display screen, by a conversion screen thus remotely generating a three-dimensional image, the method also including an adaptation of the number of screen pixels for encoding a 3D image pixel, according to the desired optimal viewing distance Dₒₚₜ.

The term “image pixel” refers to a pixel of monochromatic or color information of the matrix image for a single viewpoint. The term “3D image pixel” refers to a pixel of information on the matrix image combining P viewpoints, with P image pixels forming a 3D image pixel. The term “screen pixel” refers to a physical pixel of a display screen. On a single screen, all of the screen pixels can be of the same color, or can include a plurality of cells of different colors, for example, red, green and blue. These color cells are not necessarily connected. The color information passes in the same way for all of the colors between the image pixels and the screen pixels. A plurality of screen pixels all including P viewpoints form a 3D screen pixel.

In a first embodiment, said adaptation can include a modification of the apparent size of the 3D screen pixels, distributed at the level of at least one view point of each of the 3D image pixels. The modification can consist of a reduction or an increase in the apparent size of the 3D screen pixels.

In a second embodiment, said adaptation can include a modification of the apparent size of the 3D screen pixels, which modification includes a suppression or a duplication of at least one viewpoint of certain 3D image pixels.

In a third embodiment, said adaptation can include a modification of the apparent size of the 3D screen pixels, distributed uniformly over all of the view points of each of the 3D image pixels. The modification can consist of a reduction or an increase in the apparent size of the 3D screen pixels.

The autostereoscopic display method of the invention can also include an acquisition of the optimal viewing distance Dₒₚₜ. The Dₒₚₜ can be achieved in numerous ways. It can, for example, include a position detector locating a viewer or an input or a manual adjustment by the viewer. This manual adjustment can be assisted by a display of a graphic object for assisted positioning encoded in the matrix image.

According to another aspect of the invention, an autostereoscopic display device is proposed, which implements the method according to the invention and includes a matrix display screen, a conversion screen arranged in front of said display screen which conversion screen is arranged so as to receive and optically process a matrix image transmitted by said display screen, which matrix image is encoded so as to integrate a plurality P of view points of the same scene, which matrix image is composed of image pixels, with a pixel image including a view point, P image pixels forming a 3D image pixel including P view points, which display screen includes a matrix of screen pixels, and a plurality of screen pixels all including P view points forming a 3D screen pixel, the device also including means for adapting the number of screen pixels for encoding a 3D image pixel, according to an optimal viewing distance Dₒₚₜ of the desired autostereoscopic display device.

The device according to the invention can include a module for acquisition of the desired optimal viewing distance Dₒₚₜ of the autostereoscopic device. The module for acquisition of the desired optimal viewing distance Dₒₚₜ of the autostereoscopic device can include a position detector measuring the position of a viewer. The module for acquisition of the desired optimal viewing distance Dₒₚₜ of the autostereoscopic device can also be manually adjusted by a viewer.

The display screen according to the invention can include an electronic screen including plasma technology, liquid crystals (LCD) or any other matrix technology.

The conversion screen according to the invention can include, for example, a lenticular network or a parallax barrier.

### BRIEF DESCRIPTION OF THE DRAWINGS

Other advantages and features of the invention will appear on reading the detailed description of embodiments, which are in no way limiting, and appended drawings, in which:

FIG. 1 is a general top view of an autostereoscopic display device according to the prior art; this figure shows that the viewing of an autostereoscopic display device is optimal at a given distance;

FIG. 2 depicts, according to the prior art, a standard coding of the image pixels of a matrix image on the screen pixels of a display screen of an autostereoscopic device;

FIG. 3 depicts an embodiment, according to the invention, of the method for adapting the optimal viewing distance of an autostereoscopic device by a particular encoding of the image pixels of a matrix image on screen pixels of the display screen of an autostereoscopic device;

FIG. 4 depicts an embodiment, according to the invention, of the method for adapting the optimal viewing distance of an autostereoscopic device by a particular encoding of the image pixels of a matrix image on screen pixels of the display screen of an autostereoscopic device; and

FIG. 5 is a general top view of an autostereoscopic display device according to an embodiment of the invention.

### DETAILED DESCRIPTION OF THE DRAWINGS

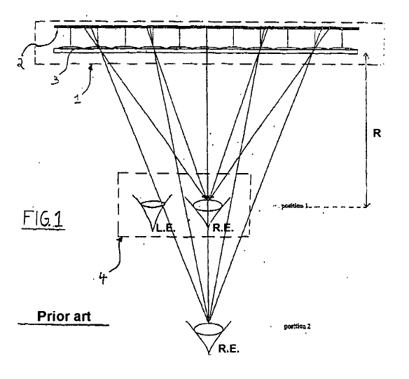

We will first describe, in reference to FIG. 1, an example of an autostereoscopic display device according to the prior art.

The autostereoscopic display device 1 of the prior art includes a matrix display screen 2, and a lenticular conversion network 3 including a layer of parallel semi-cylindrical lenses. This conversion network 3 is arranged in front of said display screen 2 at a distance almost equal to the focal distance f of the semi-cylindrical lenses of said lenticular conversion network 3.

The lenticular conversion network 3 is arranged to receive and optically process a matrix image transmitted by the display screen 2, wherein said matrix image is encoded to integrate a plurality P of view points of the same scene, and said display screen 2 includes a matrix of screen pixels each including three color cells. The processed image, the left eye LE and the right eye RE of a viewer 4 of the autostereoscopic display device 1 receive different information, thus providing the viewer with an impression of volume.

The optimal viewing distance Dₒₚₜ is the distance for which an eye of the viewer sees a single viewpoint on the entire display screen 2 through the lenticular network 3. When the eye is at a finite distance, the screen pixels (shown in the form of small dark squares on the display screen 2), which are seen at the same time are dependent on the distance D that separates the eye from the screen 2. Thus, if the dimensions of the lenticular network 3 and the display screen 2 are calculated to be optimal at a given Dₒₚₜ distance, they will not be at another distance.

It is desirable to encode a matrix image on a matrix display screen. The stereoscopic effect must necessarily be a horizontal effect due to the morphology of the eyes. Therefore the encoding of the stereoscopy must necessarily be horizontal. This is why we will consider below a horizontal line of the 2D matrix of screen pixels of the display screen. To illustrate the invention, we will consider the case in which:
The matrix image integrates P viewpoints of the same scene and is composed of image pixels, P image pixels forming a 3D image pixel integrating P different viewpoints. Vj(k-3D) defines the image pixel of the j^{th} viewpoint of the k^{th} 3D image pixel.
The display screen 2 includes a matrix of screen pixels of a constant width px, with a plurality of screen pixels all including P viewpoints of the same scene forming a 3D screen pixel. P(i) defines the i^{th} screen pixel.
The conversion screen is a lenticular network 3 including a layer of semi-cylindrical lenses parallel to one another, which semi-cylindrical lenses have a width equal to pr1 and a focal distance equal to f.

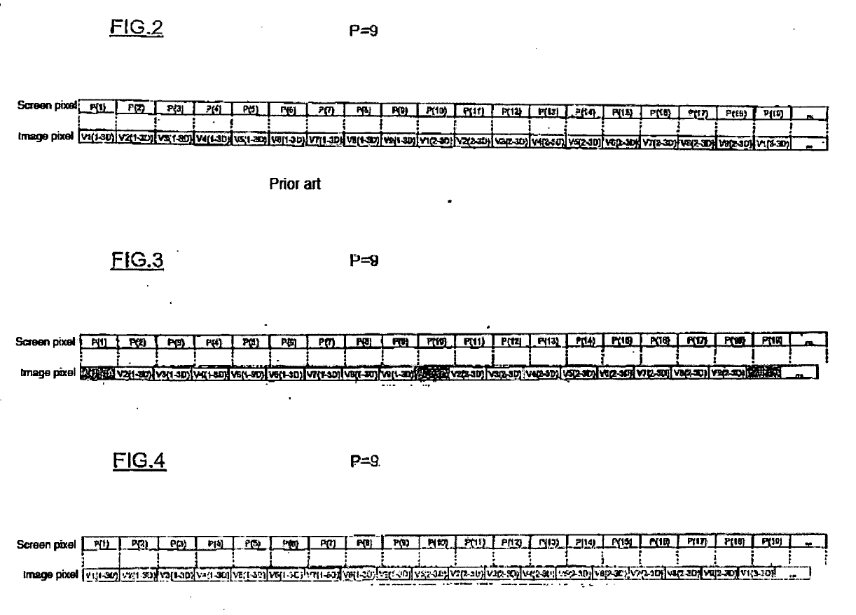

FIG. 2 shows, according to the prior art, a standard encoding of image pixels of a matrix image on the screen pixels of a display screen of an autostereoscopic device. In the case shown here, P=9, a screen pixel integrates an image pixel. In other words, the operation performed is as follows:

P(1)=V1(1-3D)

P(2)=V2(1-3D)

P(3)=V3(1-3D)

P(4)=V4(1-3D)

P(5)=V5(1-3D)

P(6)=V6(1-3D)

P(7)=V7(1-3D)

P(8)=V8(1-3D)

P(9)=V9(1-3D)

P(10)=V1(2-3D)

P(45)=V9(5-3D)

P(46)=V1(6-3D)

P(47)=V2(6-3D)

The width p3D of a 3D screen pixel integrating P different viewpoints is therefore equal to p3D=P * px. The optimal viewing distance Dₒₚₜ is then related to p3D, pr1, px, P and f by the relation:

P*px−p3D=pr1*(Dₒₚₜ+f)/Dₒₚₜ

It is not possible to modify the pitch of the lenticular network pri, or the focal f of the semi-cylindrical lenses, or the width of the screen pixels px of the display screen without changing the autostereoscopic device. If it is desirable to adapt the optimal viewing distance of the autostereoscopic device from the value Dₒₚₜ to a new value NDₒₚₜ, it is possible, however, to computationally modify the width of the 3D screen pixel p3D seen by the viewer by a new value Np3D.

These quantities are associated by the relation:

Np3D=pr1*(NDₒₚₜ+f)/NDₒₚₜ

More precisely, the information to be obtained with the apparent pixel pitch desired is sent on the screen pixels. This amounts to sending, on the screen pixels, the percentage of views for physically modifying the position of the information provided to the viewer:
if NDₒₚₜ>Dₒₚₜ, then Np3D<p3D, it is necessary to reduce the apparent size, and the reduction rate per 3D screen pixel is:

(p3D−Np3D)/px
if NDₒₚₜ<Dₒₚₜ, then Np3D>p3D, it is necessary to increase the apparent size, and the rate of increase per 3D screen pixel is:

(Np3D−p3D)/px

FIG. 3 shows the case in which P=9, and in which the apparent horizontal size of the 3D screen pixel is reduced by 10% of the size of a single screen pixel (reduction of around 1.1% of the apparent size of the 3D screen pixel). In this example, the 10% size reduction of the 3D screen pixel is attributed to the first view point of each of the 3D image pixels (in gray in the figure). The operation performed is as follows:

P(1)=0.9*V1(1-3D)+0.1*V2(1-3D)

P(2)=0.9*V2(1-3D)+0.1*V3(1-3D)

P(3)=0.9*V3(1-3D)+0.1*V4(1-3D)

P(4)=0.9*V4(1-3D)+0.1*V5(1-3D)

P(5)=0.9*V5(1-3D)+0.1*V6(1-3D)

P(6)=0.9*V6(1-3D)+0.1*V7(1-3D)

P(7)=0.9*V7(1-3D)+0.1*V8(1-3D)

P(8)=0.9*V8(1-3D)+0.1*V9(1-3D)

P(9)=0.9*V9(1-3D)+0.1*V1(2-3D)

P(10)=0.8*V1(2-3D)+0.2*V2(2-3D)

P(11)=0.8*V1(2-3D)+0.2*V3(2-3D)

P(18)=0.8*V9(2-3D)+0.2*V1(3-3D)

P(19)=0.7*V1(3-3D)+0.3*V2(3-3D)

P(45)=0.5*V9(5-3D)+0.5*V1(6-3D)

P(46)=0.4*V1(6-3D)+0.6*V2(6-3D)

P(47)=0.4*V2(6-3D)+0.6*V3(6-3D)

In this case, the reduction is therefore performed 3D screen pixel by 3D screen pixel.

Another way to encode the reduction or increase in the apparent size of the screen pixel would have been to do so for each integral pitch of screen pixels. We will no longer work with a view percentage to move from one screen pixel to another, but with roundings to the nearest integer value found. Thus, to obtain a reduction in the size of the 3D screen pixel identical to that obtained in the case shown in FIG. 3, the encoding would be almost identical to the so-called “standard” shown in FIG. 2 up to the screen pixel P(46):

P(1)=V1(1-3D)

P(2)=V2(1-3D)

P(3)=V3(1-3D)

P(4)=V4(1-3D)

P(5)=V5(1-3D)

P(6)=V6(1-3D)

P(7)=V7(1-3D)

P(8)=V8(1-3D)

P(9)=V9(1-3D)

P(10)=V1(2-3D)

P(45)=V9(5-3D)

P(46)=V2(6-3D)

P(47)=V3(6-3D)

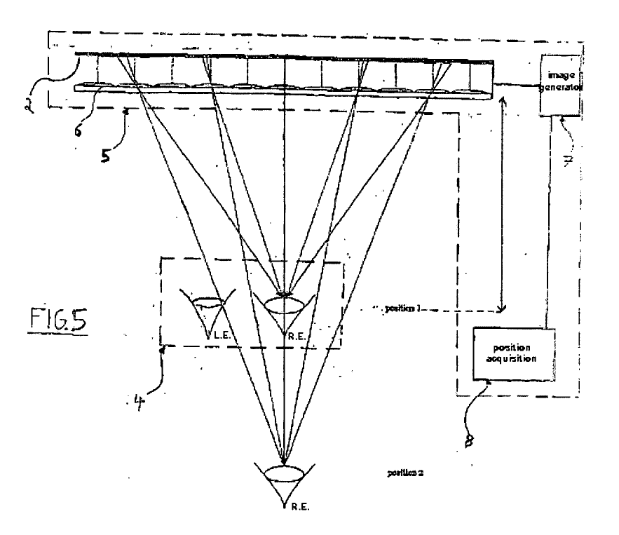

It is also possible to image a reduction along the entire 3D screen pixel itself. For the example shown in FIG. 4, the apparent size of the 3D screen pixel is reduced by 9%. The apparent reduction in size of the 3D screen pixels is distributed over all of the viewpoints of the 3D image pixels. The operation performed is as follows:

P(1)=0.99*V1(1-3D)+0.01*V2(1-3D)

P(2)=0.98*V2(1-3D)+0.02*V3(1-3D)

P(3)=0.97*V3(1-3D)+0.03*V4(1-3D)

P(4)=0.96*V4(1-3D)+0.04*V5(1-3D)

P(5)=0.95*V5(1-3D)+0.05*V6(1-3D)

P(6)=0.94*V6(1-3D)+0.06*V7(1-3D)

P(7)=0.93*V7(1-3D)+0.07*V8(1-3D)

P(8)=0.92*V8(1-3D)+0.08*V9(1-3D)

P(9)=0.91*V9(1-3D)+0.09*V1(2-3D)

P(10)=0.90*V1(2-3D)+0.10*V2(2-3D)

P(11)=0.89*V1(2-3D)+0.11*V3(2-3D)

P(18)=0.82*V9(2-3D)+0.18*V1(3-3D)

P(19)=0.81*V1(3-3D)+0.19*V2(3-3D)

FIG. 5 shows an autostereoscopic display device 5 according to the invention. This device 5 includes a matrix display screen 2, a conversion screen 6 shown diagrammatically here with a lenticular network, an electronic image generation module 7 and a module 8 for acquisition of the optimal viewing distance Dₒₚₜ separating a viewer 4 from the device 5.

The acquisition of this distance is performed, for example, via an optical detector locating the viewer, or via a manual input by the viewer. This acquisition sets the desired optimal viewing distance of the device 5. This information is then transmitted to the electronic image generation module 7, which consequently encodes, for the display screen 2, matrix images integrating a plurality P of viewpoints of the same scene. The display screen 2 includes a matrix of screen pixels each including three color cells. The conversion screen 6 is arranged to receive and optically process a matrix image transmitted by the display screen 2. The processed image, the left eye LE and the right eye RE of the viewer 4 receive different information, thus giving the viewer the impression of volume.

Of course, the invention is not limited to the examples described above, and numerous modifications can be made to these examples without going beyond the scope of the invention.

In particular, there are numerous ways in which to combine one or more image pixels with one or more screen pixels, and, in addition, the latter can be combined with one another within the same autostereoscopic device. Finally, the invention can be implemented with numerous types of matrix structure display screens or other types of conversion screens such as parallax barriers.

1. A method for autostereoscopic display comprising:
encoding a matrix image on a matrix display screen, wherein said matrix image integrates a set of P view points of a same scene, said matrix image comprising image pixels, an image pixel including a view point, and P image pixels forming a 3D image pixel including P view points, and wherein said display screen includes a matrix of screen pixels, a plurality of screen pixels comprising P points of view forming a 3D screen pixels;
-receiving and optically processing the matrix image, transmitted by said display screen, by a conversion screen thus remotely generating a three-dimensional image; and
creating an adaptation of a number of screen pixels for encoding a 3D image pixel, according to a desired optimal viewing distance Dₒₚₜ.

2. The method according to claim 1, wherein said adaptation comprises a modification of an apparent size of the 3D screen pixels, distributed at the level of at least one view point of each of the 3D image pixels.

3. The method according to claim 1, wherein said adaptation comprises a modification of an apparent size of the 3D screen pixels, the modification including a-suppression or a duplication of at least one view point of certain 3D image pixels.

4. The method according to claim 1, wherein said adaptation comprises a modification of an apparent size of the 3D screen pixels, distributed uniformly over all of the view points of each of the 3D image pixels.

5. The method according to claim 1, the method further comprising acquiring the desired optimal viewing distance Dₒₚₜ of the autostereoscopic devices.

6. The method according to claim 5, wherein the acquisition of the desired optimal viewing distance Dₒₚₜ of the autostereoscopic device comprises a measurement of a position of a viewer via a position detector.

7. The method according to claim 5, wherein the acquisition of the desired optimal viewing distance Dₒₚₜ of the autostereoscopic device comprises a manual adjustment of said device by a viewer.

8. The method according to claim 7, wherein the manual adjustment is assisted by a display of a graphic object for assisted positioning encoded in the matrix image.

9. An autostereoscopic display device comprising:
a matrix display screen;
a conversion screen positioned in front of said matrix display screen, such that the conversion screen is positioned so as to receive and optically process a matrix image transmitted by said matrix display screen;
wherein the matrix image is encoded so as to integrate a plurality P of view points of a same scene, and wherein the matrix image is composed of image pixels, with a pixel image including a view point, and P image pixels forming a 3D image pixel including P view points, and
wherein the display screen comprises a matrix of screen pixels, and a plurality of screen pixels all including P view points forming a 3D screen pixel; and, means for adapting the number of screen pixels for encoding a 3D image pixel, according to an optimal viewing distance Dₒₚₜ of the desired autostereoscopic display device.

10. The device according to claim 9, further comprising a module adapted to acquire the desired optimal viewing distance Dₒₚₜ of the autostereoscopic device.

11. The device according to claim 10, wherein the module for acquisition of the desired optimal viewing distance Dₒₚₜ of the autostereoscopic device comprises a position detector adapted to measure a position of a viewer.

12. The device according to claim 10, wherein the module adapted to acquire the desired optimal viewing distance Dₒₚₜ of the autostereoscopic device is manually adjusted by a viewer.

13. The device according to claim 9, wherein the display screen comprises an electronic plasma screen.

14. The device according to claim 9, wherein the display screen comprises an electronic liquid crystal (LCD) screen.

15. The device according to claim 9, wherein the conversion screen comprises a lenticular network.

16. The device according to claim 9, wherein the conversion screen comprises a parallax barrier.
